(19) United States
(12) Patent Application Publication
(10) Pub. No.: US 2017/0061643 A1
(43) Pub. Date: Mar. 2, 2017

(54) USER TERMINAL, OBJECT RECOGNITION SERVER, AND METHOD FOR NOTIFICATION

(71) Applicant: OPTiM CORPORATION, Saga (JP)

(72) Inventor: Shunji SUGAYA, Tokyo (JP)

(21) Appl. No.: 15/162,693

(22) Filed: May 24, 2016

(30) Foreign Application Priority Data
Aug. 28, 2015 (JP) 2015-169754

(51) Int. Cl. G06T 7/20; H04N 5/232; G06K 9/00

(52) U.S. Cl. CPC G06T 7/2033; G06K 9/00335; H04N 5/23293; G06T 2207/20112

(57) ABSTRACT

The present invention is to provide a user terminal, an object recognition server, and a method for notification that notify the user that an object has been moved to the arbitrarily set location to improve the user's convenience. The user terminal 100 that notifies the movement of an object imaged with a camera 200 to a user receives an object specified by on-screen guide from the user; recognizes the image of the specified object, references an object recognition database, and extracts a feature amount to recognize the object; receives a predetermined boundary input by on-screen guide from the user; and provides a notification when the recognized object comes in contact with the boundary.

### CROSS REFERENCE TO RELATED APPLICATIONS

This application claims priority to Japanese Patent Application No. 2015-169754 filed on Aug. 28, 2015, the entire contents of which are incorporated by reference herein.

### TECHNICAL FIELD

The present invention relates to a user terminal, an object recognition server, and a method for notification that notify the movement of an object imaged with a camera to the user.

### BACKGROUND ART

Recently, images such as still and moving images taken by an imaging device such as a camera have been analyzed to recognize objects.

For example, Patent Document 1 discloses that an object is recognized and identified based on the luminescence from a luminescent part that the object has.

### CITATION LIST

### Patent Literature

Patent Document 1: JP 2011-76357 A

### SUMMARY OF INVENTION

In the constitution of Patent Document 1, the location of an object is recognized on an image by associating ID information on the object with the image of the object that is recognized by luminescence from the object. However, the constitution is less convenient because requiring the object to produce luminescence and needing to acquire the ID information.

Moreover, in the constitution of Patent Document 1, the location of a mobile terminal on an image can be recognized. However, the constitution is less convenient because not notifying the user when she or he has come to the arbitrarily set location.

Therefore, the present invention focuses on the point that the user is notified that an object has been moved to the arbitrarily set location.

The objective of the present invention is to provide a user terminal, an object recognition server, and a method for notification that notify the user that an object has been moved to the arbitrarily set location to improve the user's convenience.

The first aspect of the present invention provides a user terminal that notifies the movement of an object imaged with a camera to a user, including:
an object receiving unit that receives an object specified by on-screen guide from the user;
an object recognition unit that recognizes the image of the specified object, references an object recognition database, and extracts a feature amount to recognize the object;
a boundary receiving unit that receives a predetermined boundary input by on-screen guide from the user; and
a notification unit that provides a notification when the recognized object comes in contact with the boundary.

According to the first aspect of the present invention, a user terminal that notifies the movement of an object imaged with a camera to a user receives an object specified by on-screen guide from the user; recognizes the image of the specified object, references an object recognition database, and extracts a feature amount to recognize the object; receives a predetermined boundary input by on-screen guide from the user; and provides a notification when the recognized object comes in contact with the boundary.

The first aspect of the present invention falls into the category of a user terminal, but the categories of an object recognition server and a method for notification have the same functions and effects.

The second aspect of the present invention provides the user terminal according to the first aspect of the present invention further including a boundary change unit that changes the received boundary, in which the notification unit provides a notification when the recognized object comes in contact with the changed boundary.

According to the second aspect of the present invention, the user terminal according to the first aspect of the present invention changes the received boundary and provides a notification when the recognized object comes in contact with the changed boundary.

The third aspect of the present invention provides the user terminal according to the first aspect of the present invention, in which the boundary receiving unit receives a plurality of predetermined boundaries input, and the notification unit that provides a notification when the recognized object comes in contact with one or some of the received boundaries.

According to the third aspect of the present invention, the user terminal according to the first aspect of the present invention receives a plurality of predetermined boundaries input and provides a notification when the recognized object comes in contact with one or some of the received boundaries.

The fourth aspect of the present invention provides an object recognition server being communicatively connected with a user terminal that notifies the movement of an object imaged with a camera to a user, including:
an object recognition database that associates and stores the identifier of an object with the feature amount of the object;
an object information receiving unit that receives information on an object specified from the user terminal;
an object recognition unit that looks up the object recognition server, and extracts a feature amount, and acquires the identifier of the object, based on the received information, to recognize the object; and
an identifier transmitting unit that transmits the identifier of the recognized object to the user terminal.

According to the fourth aspect of the present invention, an object recognition server being communicatively connected with a user terminal that notifies the movement of an object imaged with a camera to a user has an object recognition database that associates and stores the identifier of an object with the feature amount of the object; receives information on an object specified from the user terminal; looks up the object recognition server, and extracts a feature amount, and acquires the identifier of the object, based on the received information, to recognize the object; and transmits the identifier of the recognized object to the user terminal.

The fifth aspect of the present invention provides a method for notification that notifies the movement of an object imaged with a camera to a user, including the steps of;
receiving an object specified by on-screen guide from the user;
recognizing the image of the specified object, referencing an object recognition database, and extracting a feature amount to recognize the object;
receiving a predetermined boundary input by on-screen guide from the user; and
providing a notification when the recognized object comes in contact with the boundary.

The present invention can provide a user terminal, an object recognition server, and a method for notification that notify the user that an object has been moved to the arbitrarily set location to improve the user's convenience.

### BRIEF DESCRIPTION OF DRAWINGS

FIG. 1 shows a schematic diagram of the object recognition system 1 according to the first embodiment.

FIG. 2 shows a schematic diagram of the object recognition system 1 according to the second embodiment.

FIG. 3 shows an overall configuration diagram of the object recognition system 1 according to the first embodiment.

FIG. 4 shows an overall configuration diagram of the object recognition system 1 according to the second embodiment.

FIG. 5 shows a functional block diagram of the user terminal 100 and the camera 200 in the first embodiment.

FIG. 6 shows a functional block diagram of the object recognition server 10, the user terminal 100, and the camera 200 in the second embodiment.

FIG. 7 shows a flow chart of the object recognition process performed by the user terminal 100 and the camera 200 in the first embodiment.

FIG. 8 shows a flow chart of the change process performed by the user terminal 100 in the first embodiment.

FIG. 9 shows a flow chart of the object recognition process performed by the object recognition server 10, the user terminal 100, and the camera 200 in the second embodiment.

FIG. 10 shows a flow chart of the change process performed by the user terminal 100 in the second embodiment.

FIG. 11 shows a taken image that the user terminal 100 displays.

FIG. 12 shows an object line 103 that the user terminal 100 displays.

FIG. 13 shows the object recognition database that the user terminal 100 or the object recognition server 10 stores.

FIG. 14 shows a boundary 104 that the user terminal 100 displays.

FIG. 15 shows an object 102 and a boundary 104 that the user terminal 100 displays.

FIG. 16 shows a notification 105 that the user terminal 100 displays.

FIG. 17 shows an object-changed notification 106 that the user terminal 100 displays.

FIG. 18 shows a boundary-changed notification 107 that the user terminal 100 displays.

### DESCRIPTION OF EMBODIMENTS

Embodiments of the present invention will be described below with reference to the attached drawings. However, this is illustrative only, and the technological scope of the present invention is not limited thereto.

### Overview of Object Recognition System 1

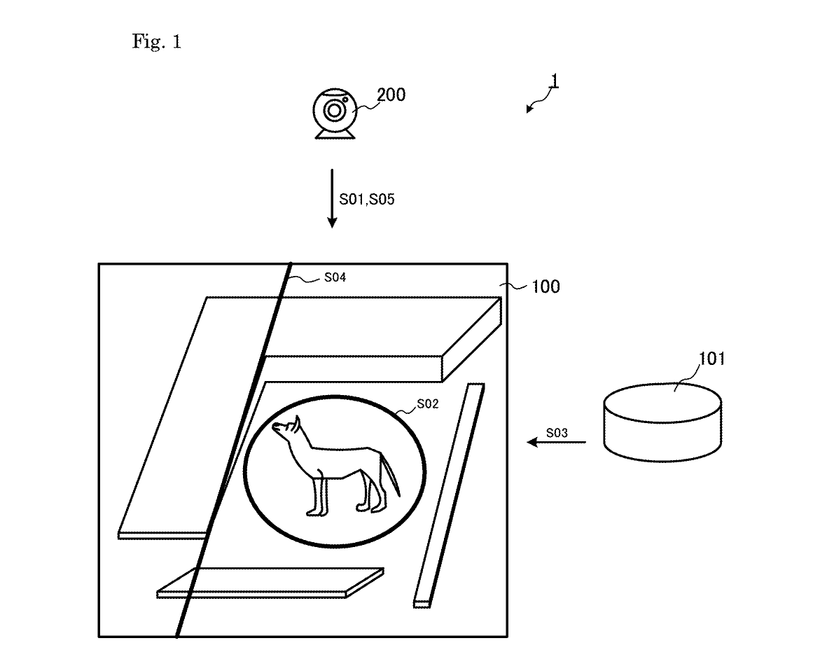

FIG. 1 shows an overview of the object recognition system 1 according to a preferable first embodiment of the present invention. The object recognition system 1 includes a user terminal 100, an object recognition database 101, and a camera 200. In the first embodiment, the user terminal 100 has the object recognition database 101.

In the object recognition system 1, the user terminal 100 may be communicative with the object recognition database 101 through LAN or a public line network such as the Internet, or may have the object recognition database 101. The user terminal 100 is communicative with a camera 20 through LAN or a public line network.

First, the user terminal 100 starts an application for object recognition and acquires a moving or still image, etc., taken with the camera 200 (step S01). The user terminal 100 displays the acquired image.

Then, the user terminal 100 inputs an object line that specifies an object to be recognized in the displaying image (step S02). In the step S02, the user terminal 100 receives an object line tapped from the user. The object line encloses an object with a circle or a straight line to distinguish the object from the rest of the image. The object line may be not a line but another form such as a dot or an arrow to specify an object.

The user terminal 100 recognizes the image enclosed with the object line, extracts the feature amount of the image enclosed with this object line, references the object recognition database 101 based on the extracted feature amount, and recognizes the object enclosed with the object line (step S03).

Then, the user terminal 100 receives a boundary input to the displaying image (step S04). In the step S04, the user terminal 100 receives a boundary tapped from the user. For example, the boundary partitions a specific area from others in an image with a straight line, a curve line, a circle, a broken line, etc. The boundary may be not a line but another form such as a dot or an arrow to specify an area in the image.

The user terminal 100 periodically acquires an image taken with the camera 200 (step S05) and judges whether or not the object recognized in the step S03 comes in contact with the boundary received in the step S04. If the recognized object comes in contact with the boundary, the user terminal 100 provides a notification.

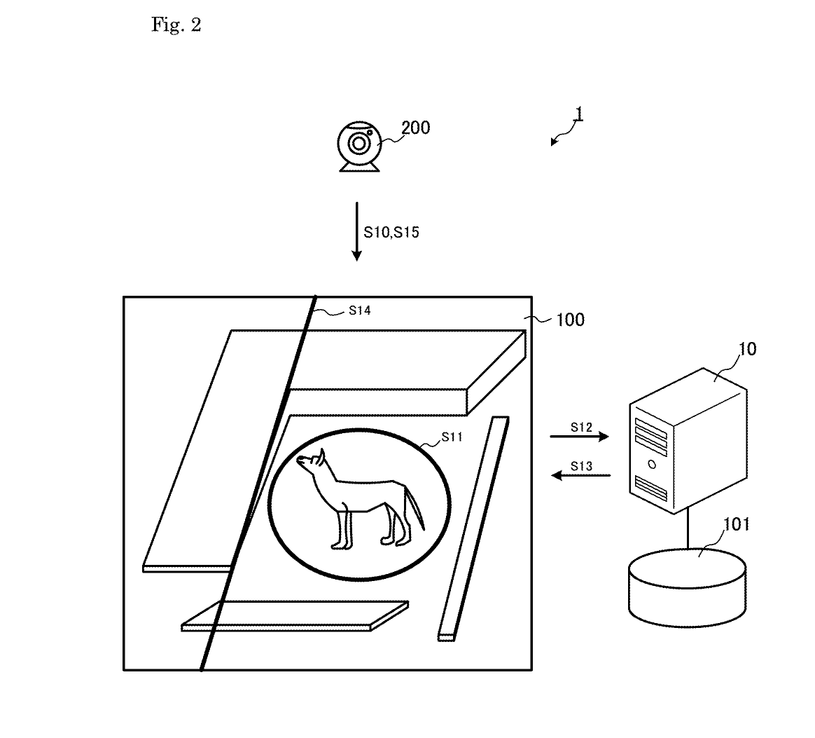

FIG. 2 shows an overview of the object recognition system 1 according to a preferable second embodiment of the present invention. The object recognition system 1 includes an object recognition server 10, a user terminal 100, an object recognition database 101, and a camera 200. In the second embodiment, the object recognition server 10 has the object recognition database 101.

In the object recognition system 1, the user terminal 100 may be communicative with the object recognition server 10 through LAN or a public line network such as the Internet. The user terminal 100 is communicative with a camera 200 through LAN or a public line network.

First, the user terminal 100 starts an application for object recognition and acquires a moving or still image, etc., taken with the camera 200 (step S10). The user terminal 100 displays the acquired image.

Then, the user terminal 100 inputs an object line that specifies an object to be recognized in the displaying image (step S11). In the step S11, the user terminal 100 receives an object line tapped from the user. The object line encloses an object with a circle or a straight line to distinguish the object from the rest of the image. The object line may be not a line but another form such as a dot or an arrow to specify an object.

The user terminal 100 extracts image data within the area enclosed with the object line and transmits this image data to the object recognition server 10 (step S12). The object recognition server 10 extracts the feature amount of this image data, references the object recognition database 101 based on the extracted feature amount, and recognizes the object contained in this image data.

The object recognition server 10 transmits the recognized object data to the user terminal 100 (step S13). In the step S13, the object recognition server 10 transmits the identifier of the recognized object as object data.

Then, the user terminal 100 receives a boundary input to the displaying image (step S14). In the step S14, the user terminal 100 receives a boundary tapped from the user. For example, the boundary partitions a specific area from others in an image with a straight line, a curve line, a circle, a broken line, etc. The boundary may be not a line but another form such as a dot or an arrow to specify an area in the image.

The user terminal 100 periodically acquires an image taken with the camera 200 (step S15) and judges whether or not the object recognized by the object recognition server 10 comes in contact with the boundary received in the step S14. If the recognized object comes in contact with the boundary, the user terminal 100 provides a notification.

### FIRST EMBODIMENT

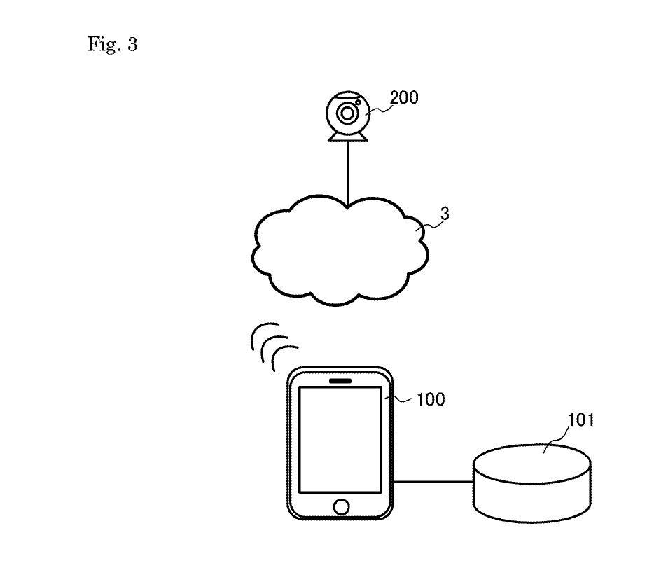

FIG. 3 shows the system configuration of the object recognition system 1 according to a preferable first embodiment of the present invention. The object recognition system 1 includes a user terminal 100, a camera 200, a public line network 3 (e.g. the Internet network, a third or a fourth generation network), and an object recognition database 101.

The user terminal 100 is a home or an office appliance with a capability of data communication, which is expected to be carried with the user. Examples of the user terminal 100 include information appliances such as a mobile phone, a mobile terminal, a net book terminal, a slate terminal, an electronic book terminal, and a portable music player.

The camera 200 is an imaging device that can take a moving or still image, etc., such as a web camera, which has a capability of data communication with the user terminal 100. The camera 200 transmits the taken image to the user terminal 100.

The object recognition database 101 associates the identifier of an object that is to be described later with a feature amount. In this embodiment, the user terminal 100 has the object recognition database 101.

### Functions

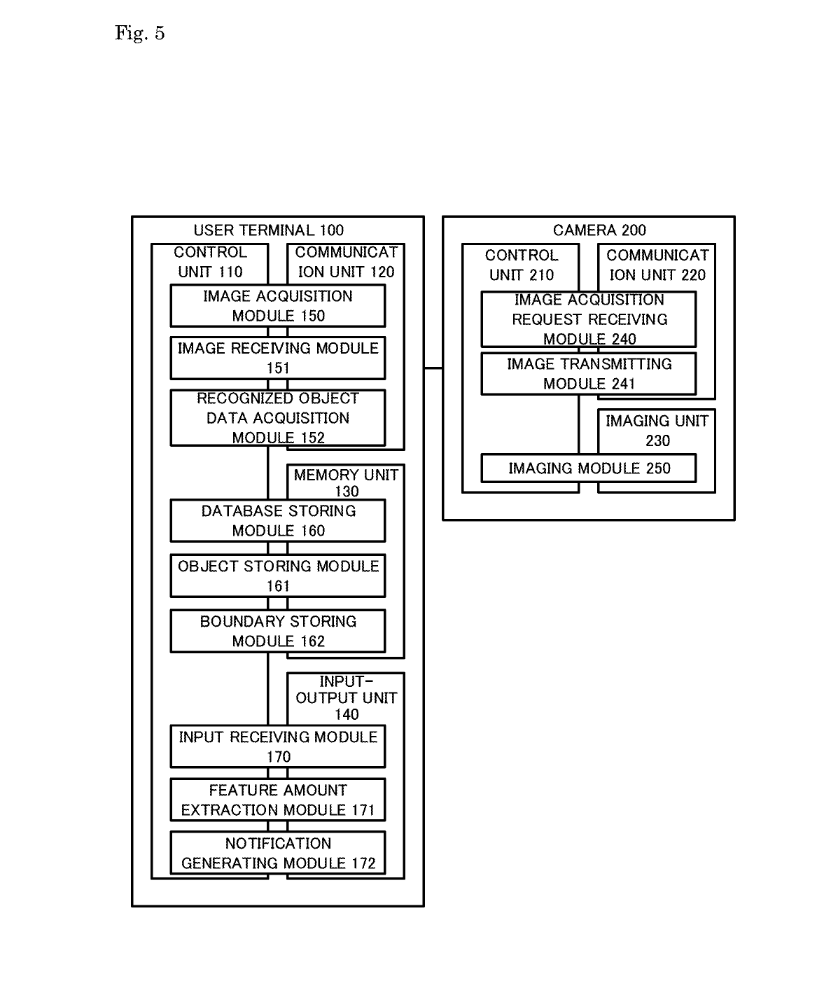

The structure of each unit will be described below based on FIG. 5

The user terminal 100 includes a control unit 110 such as a central processing unit (hereinafter referred to as “CPU”), random access memory (hereinafter referred to as “RAM”), and read only memory (hereinafter referred to as “ROM”) and a communication unit 120 such as a device capable of communicating with other devices, for example a Wireless Fidelity or Wi-Fi® enabled device complying with IEEE 802.11.

The user terminal 100 also includes a memory unit 130 that stores the object recognition database 101 to be described later, such as a hard disk, a semiconductor memory, a record medium, or a memory card to store data. The user terminal 100 also includes an input-output unit 140 including a display unit outputting and displaying data and images that have been processed by the control unit 110; and a touch panel, a keyboard, and a mouse that receive an input from a user. The user terminal 100 also has a clock function to acquire the time, a location information acquisition device, and various sensors that acquires the altitude, the signal intensity, the inclination, and the acceleration, etc.

In the user terminal 100, the control unit 110 reads a predetermined program to run an image acquisition module 150, an image receiving module 151, and a recognized object data acquisition module 152 in cooperation with the communication unit 120. Furthermore, in the user terminal 100, the control unit 110 reads a predetermined program to run a database storing module 160, an object storing module 161, and a boundary storing module 162 in cooperation with the memory unit 130. Still furthermore, in the user terminal 100, the control unit 110 reads a predetermined program to run an input receiving module 170, a feature amount extraction module 171, and a notification generating module 172 in cooperation with the input-output unit 140.

The camera 200 includes a control unit 210 including a CPU, a RAM, and a ROM; and a communication unit 220 such as a device capable of communicating with other devices, for example, a Wi-Fi® enabled device complying with IEEE 802.11 in the same way as the user terminal 100.

The camera 200 also includes an imaging unit 230 including an imaging device and a lens to take still and moving images, etc.

In the camera 200, the control unit 210 reads a predetermined program to run to achieve an image acquisition request receiving module 240 and an image transmitting module 241 in cooperation with the communication unit 220. Furthermore, in the camera 200, the control unit 210 reads a predetermined program to run an imaging module 250 in cooperation with the imaging unit 230.

### Object Recognition Process

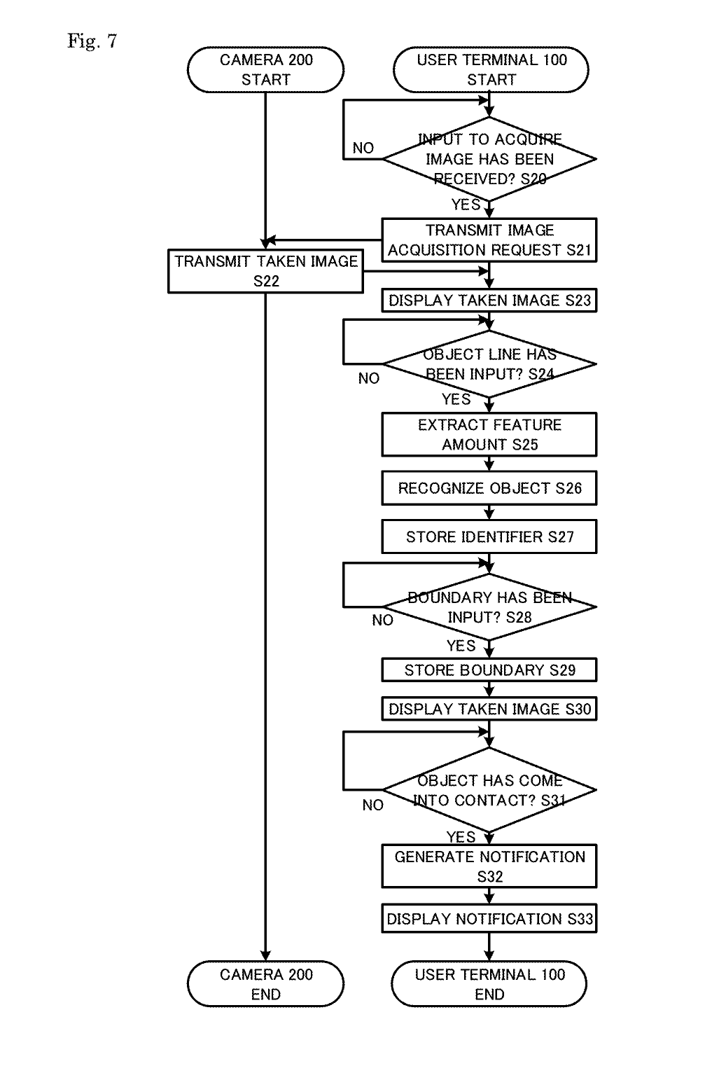

FIG. 7 shows a flow chart of the object recognition process performed by the user terminal 100 and the camera 200 in the first embodiment. The tasks executed by the modules of the above-mentioned units will be described below with this process.

First, the input receiving module 170 of the user terminal 100 judges whether or not the input receiving module 170 has received an input to acquire a moving or still image (step S20). In the step S20, the input receiving module 170 judges whether or not the user has started an application for object recognition and whether or not the user has input an instruction to acquire an image. In the step S20, if judging that the input receiving module 170 has not received an instruction to acquire an image (NO), the input receiving module 170 repeats this step until receiving the input.

On the other hand, if judging that the input receiving module 170 of the user terminal 100 has received an instruction to acquire an image (YES) in the step S20, the image acquisition module 150 of the user terminal 100 transmits an image acquisition request to the camera 200 (step S21). In the step S21, the image acquisition request transmitted from the user terminal 100 contains various types of information on an imaging point, an imaging time, and an image type.

The image acquisition request receiving module 240 of the camera 200 receives the image acquisition request transmitted from the user terminal 100. The imaging module 250 of the camera 200 images the imaging point contained in the image acquisition request. Then, the image transmitting module 241 of the camera 200 transmits the taken image to the user terminal 100 as image data (step S22).

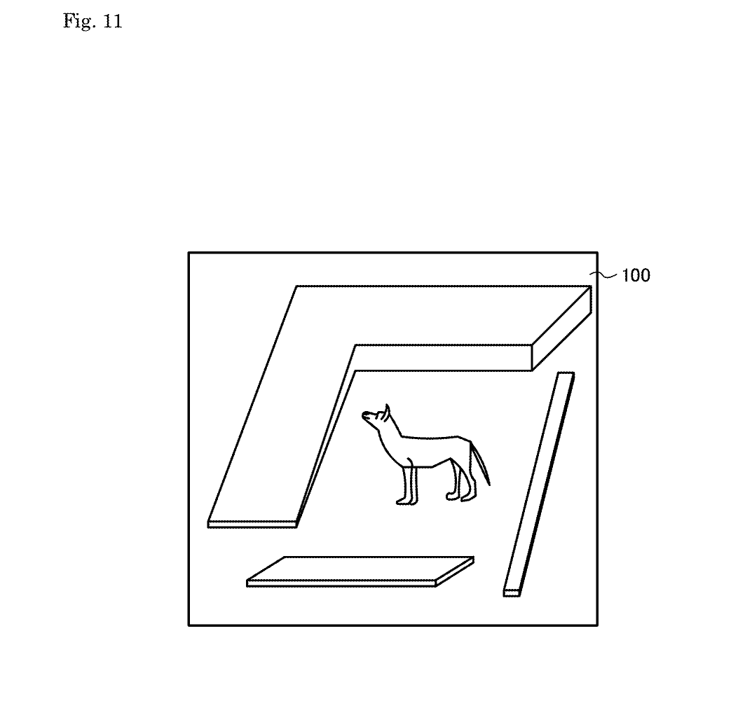

The image data receiving module 151 of the user terminal 100 receives the image data transmitted from the camera 200. The input receiving module 170 of the user terminal 100 displays the image as shown in FIG. 11 based on the received image data (step S23).

The input receiving module 170 of the user terminal 100 judges whether or not an object line 103 specifying an object 102 to be recognized that is contained in the displaying image has been input (step S24). In the step S24, the input receiving module 170 of the user terminal 100 receives the object line 103 tapped from the user. For example, the object line 103 encloses an object 102 to be recognized with a circle or a straight line to distinguish the object 102 from the rest of the image. The object line 103 may be not a line but another form such as a dot or an arrow to specify an object 102.

In the step S24, if judging that the input receiving module 170 of the user terminal 100 has not received an object line 103 (NO), the input receiving module 170 repeats this step until receiving an input of an object line 103. On the other hand, if judging that the input receiving module 170 of the user terminal 100 has received an object line 103 (YES) in the step S24, the feature amount extraction module 171 of the user terminal 100 recognizes the image enclosed with this object line 103 and extracts the feature amount of the object 102 enclosed with this object line 103 (step S25).

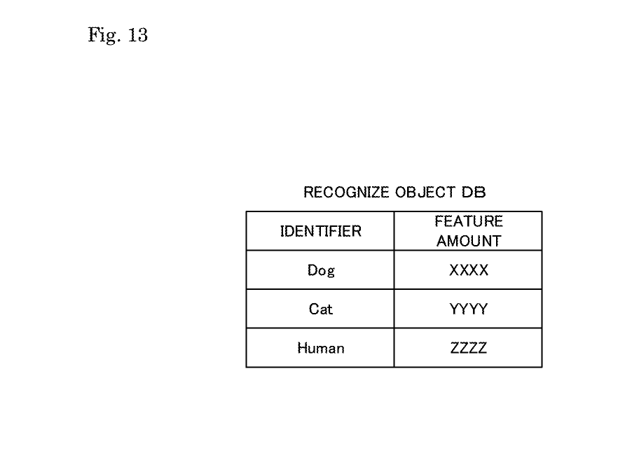

The recognized object data acquisition module 152 of the user terminal 100 references the object recognition database 101 as shown in FIG. 13 based on the feature amount of the object 102 that is extracted in the step S25 and recognizes the object 102 enclosed with the object line 103 (step S26).

### Object Recognition Database

FIG. 13 shows the object recognition database 101 that the database storing module 160 of the user terminal 100 stores. The database storing module 160 stores “Dog,” “Cat,” “Human,” etc., as the identifier of the object 102. The database storing module 160 stores the feature amount of each identifier. The database storing module 160 associates and stores the identifier of the object 102 with a feature amount in the database.

In the step S26, the recognized object data acquisition module 152 of the user terminal 100 retrieves and acquires the identifier associated with this feature amount from the object recognition database 101 based on the feature amount of the extracted object 102 to recognize the object 102.

The object storing module 161 of the user terminal 100 stores the acquired identifier as an object (step S27).

Then, the input receiving module 170 of the user terminal 100 judges whether or not a boundary 104 has been input in the displaying image (step S28). In the step S28, the input receiving module 170 of the user terminal 100 receives the boundary 104 tapped from the user. For example, the boundary 104 partitions a specific area from others in an image with a straight line, a curve line, a circle, a broken line, etc. The boundary 104 may be not a line but another form such as a dot, an arrow, or a plane to partition a specified area in the image.

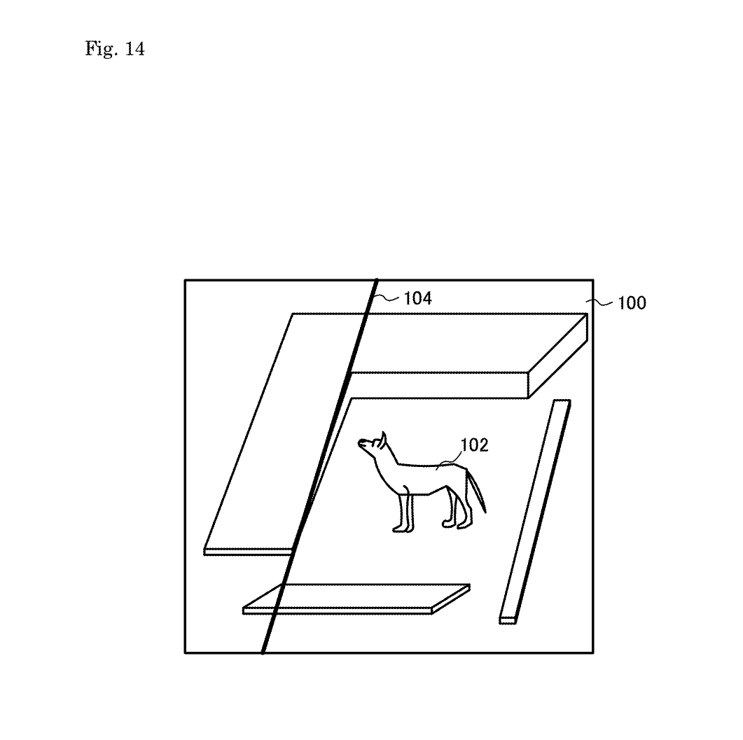

In the step S28, if judging that the input receiving module 170 of the user terminal 100 has not received a boundary 104 (NO), the input receiving module 170 repeats this step until receiving an input of a boundary 104. On the other hand, if judging that the input receiving module 170 has received a boundary 104 (YES) in the step S28 as shown in FIG. 14, the input receiving module 170 displays the received boundary 104 in the image, and then the boundary storing module 162 stores the location of the boundary 104 (step S29). In the step S29, the boundary storing module 162 stores the location of the boundary 104 based on the display unit of the user terminal 100, the acquired GPS information, or a method.

The image acquisition module 150 of the user terminal 100 acquires the image data taken with the camera 200 by performing the process steps same as the above-mentioned steps S21 to S23. The input receiving module 170 of the user terminal 100 displays the acquired image (step S30).

The input receiving module 170 of the user terminal 100 judges whether or not the object 102 contained in the acquired image data has come in contact with the boundary 104 received in the step S29 (step S31). In the step S31, the input receiving module 170 judges whether or not the displaying object 102 is on the boundary 104 to judge whether or not the object 102 has come in contact with the boundary 104. In the step S31, if judging that the object 102 has not come in contact with the boundary 104 (NO), the input receiving module 170 repeats this step.

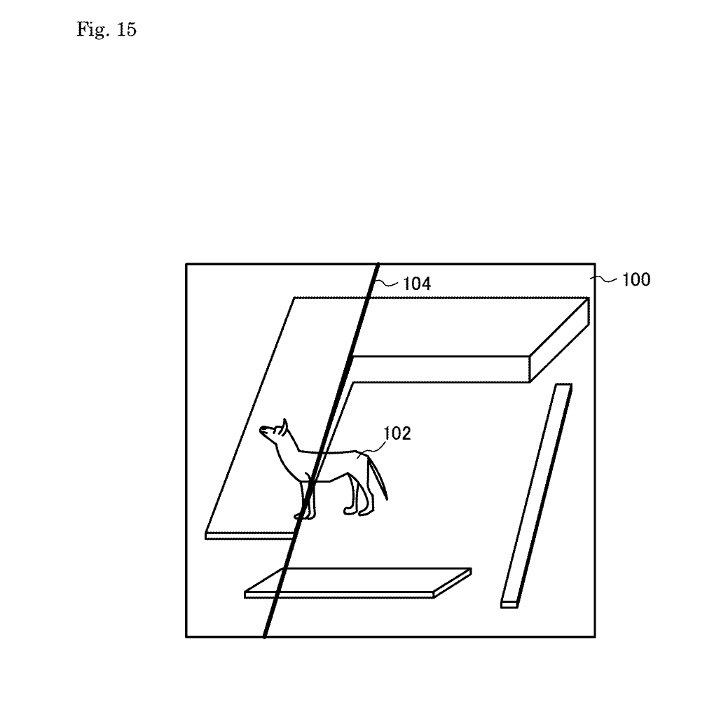

On the other hand, if the input receiving module 170 of the user terminal 100 judges that the object 102 has come in contact with the boundary 104 (YES) in the step S31 as shown in FIG. 15, the notification generating module 172 of the user terminal 100 generates the notification that the object 102 has come in contact with the boundary 104 (step S32).

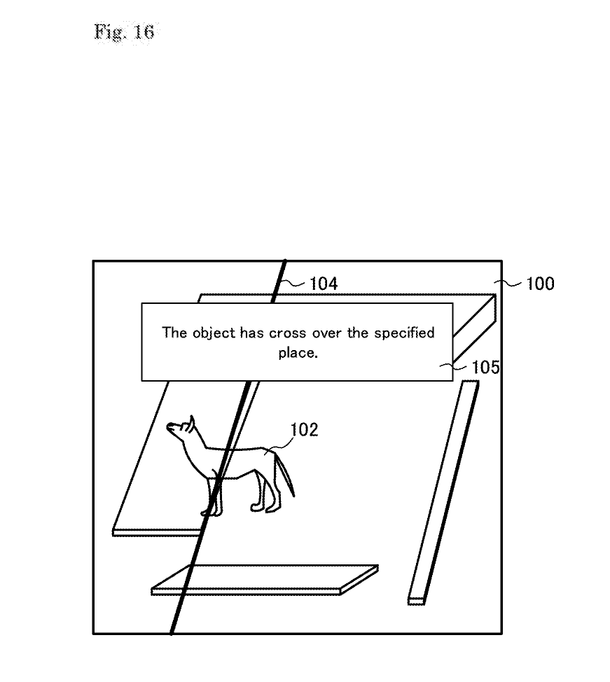

The input receiving module 170 of the user terminal 100 displays the notification generated in the step S32 as a notification 105 as shown in FIG. 16 (step S33). In the step S32, the user terminal 100 may transmits the generated notification to other terminals, etc., and the other terminals, etc., may display the notification.

In the above-mentioned embodiment, the input receiving module 170 of the user terminal 100 receives an input of one object line 103 but may be a plurality of object lines 103. The input receiving module 170 receives an input of one boundary 104 but may be a plurality of boundaries 104. In this case, the notification may be generated if the object 102 has come in contact with any or all of the plurality of boundaries 104.

Moreover, the input receiving module 170 may receive an input of not only a consecutive lined boundary 104 but also a dashed lined boundary 104. In this case, the notification generating module 172 of the user terminal 100 may generate the notification if the object 102 has come in contact with the part where the boundary 104 exists, but may not if the object 102 has come in contact with the part where the boundary 104 does not exist. The notification may be generated if any or all of the objects 102 specified by a plurality of object lines 102 have come in contact with the boundary 104.

### Change Process

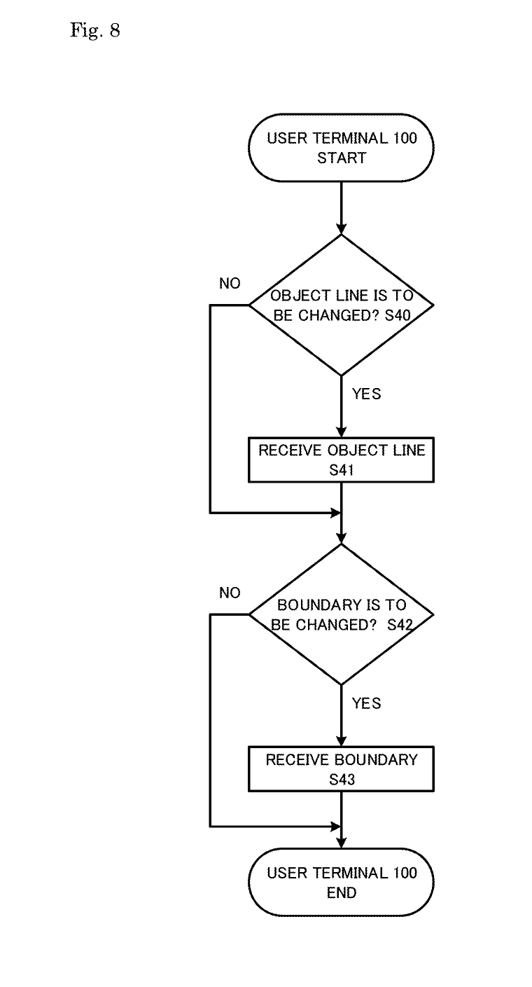

FIG. 8 shows a flow chart of the change process performed by the user terminal 100. The tasks executed by the above-mentioned modules are explained below together with this process. This process only has to be performed any time after the step S25 in the above-mentioned object recognition process.

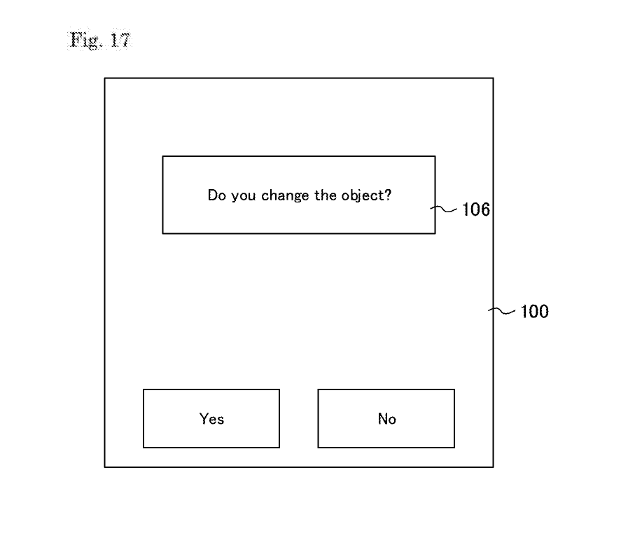

First, the input receiving module 170 of the user terminal 100 judges whether or not the input receiving module 170 has received an input to change the object 102 (step S40). In the step S40, the input receiving module 170 judges whether or not the input receiving module 170 has received an input of an object change notification as shown in FIG. 17. If judging that the input receiving module 170 has not received an input to change the object 102 (NO) in the step 40, the input receiving module 170 judges whether or not the input receiving module 170 has received an input to change the boundary 104 to be described later (step S42).

On the other hand, if judging that the input receiving module 170 of the user terminal 100 has received an input to change the object 102 (YES) in the step 40, the input receiving module 170 displays the image based on the image data acquired from the camera 200 and receives an input of an object 102 again (step S41). In the step S41, the user terminal 100 performs the process of the above-mentioned steps S25 to S27. The object storing module 161 of the user terminal 100 deletes the information on the stored object 102. In the step S41, the object storing module 161 may not delete information but may add and store information on the newly received object 102.

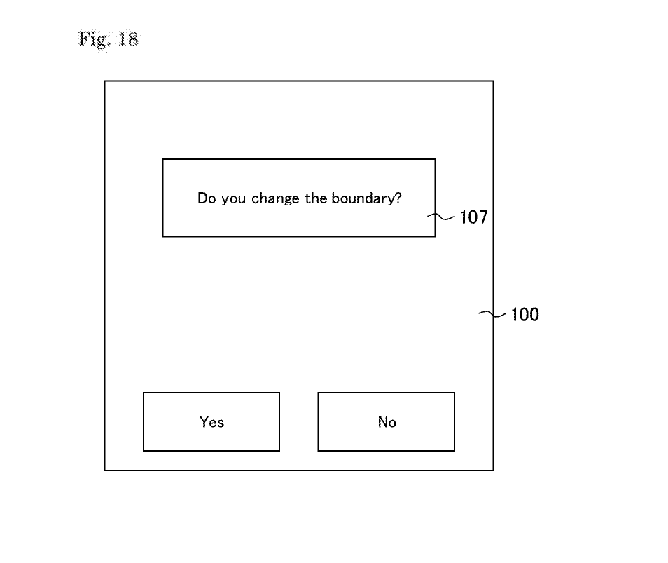

In the step S42, the input receiving module 170 of the user terminal 100 judges whether or not the input receiving module 170 has received an input of a boundary change notice 107 as shown in FIG. 18. In the step S42, if judging that the input receiving module 170 has not received an input to change the boundary 104 (NO), the input receiving module 170 ends this process.

If judging that the input receiving module 170 of the user terminal 100 has received an input to change the boundary 104 (YES) in the step 42, the input receiving module 170 displays the image based on the image data acquired from the camera 200 and receives an input of a boundary 104 again (step S43). In the step S43, the user terminal 100 performs the process of the above-mentioned step S29. The boundary storing module 162 of the user terminal 100 deletes the stored information on the boundary 104. In the step S43, the boundary storing module 162 may not delete information but may add and store information on the newly received boundary 104. Alternatively, in the step S43, if an input to change only a specific boundary 104 has been received, the boundary storing module 162 may delete information on only the boundary 104 and store information on the newly received boundary 104. Still alternatively, the boundary storing module 162 may overwrite the information on the boundary 104 duplicated with the newly input boundary 104.

If the object 102 has been changed and has come in contact with the boundary 104, the notification generating module 172 of the user terminal 100 generates the notification that the changed object 102 has come in contact with the boundary 104. If the boundary 104 has been changed and if the object 102 has come in contact with this changed boundary 104, the notification generating module 172 of the user terminal 100 generates the notification that the object 102 has come in contact with the changed boundary 104.

### SECOND EMBODIMENT

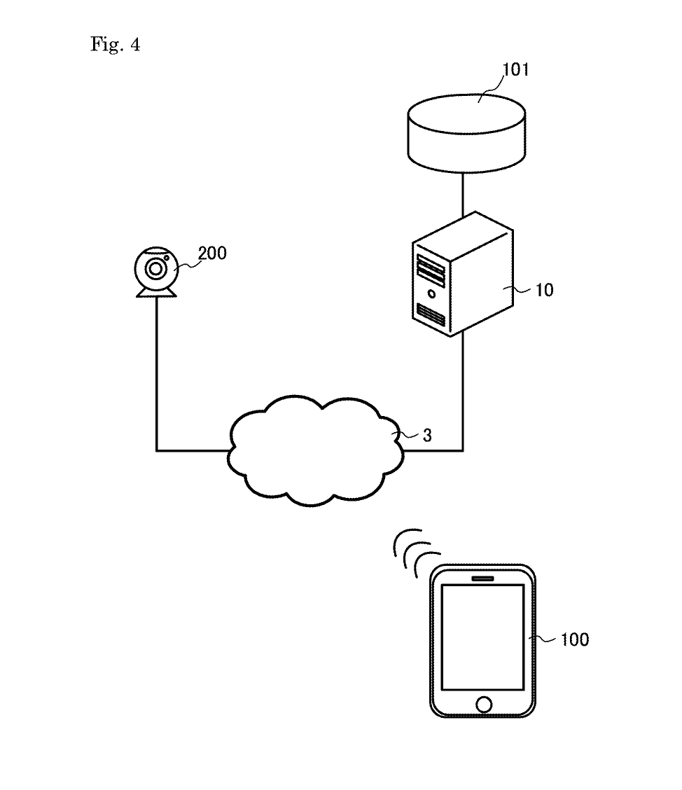

FIG. 4 shows the system configuration of the object recognition system 1 according to a preferable second embodiment of the present invention. The reference signs in the above-mentioned first embodiment are assigned to the same units and modules as those of the first embodiment. Therefore, the detailed explanation of the units and modules is omitted. The object recognition system 1 includes an object recognition server 10, a user terminal 100, an object recognition database 101, a camera 200, and a public line network 3. The difference from the above-mentioned first embodiment is that the user terminal 100 has the object recognition database 101 in the first embodiment, but the object recognition server 10 does in this embodiment.

The user terminal 100 and the camera 200 are the same as those in the first embodiment. Therefore, the detailed explanation is omitted.

The object recognition server 10 is a server device with an object recognition database 101 to be described later.

### Functions

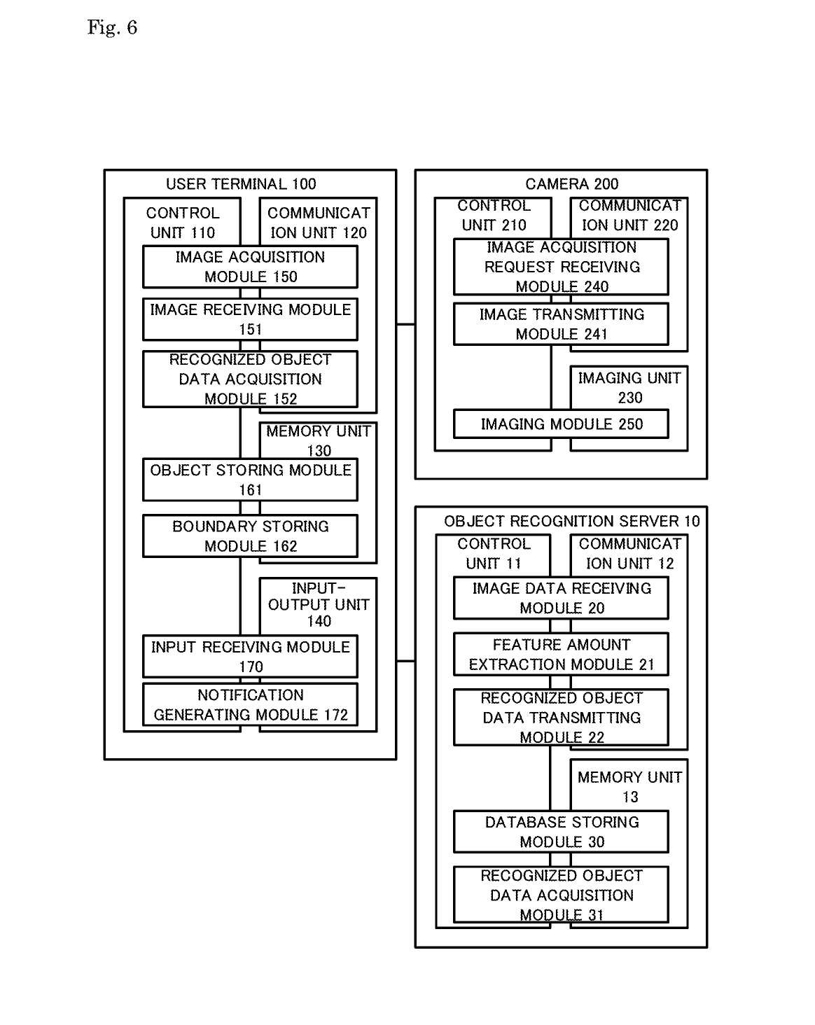

The structure of each unit will be described below with reference to FIG. 6.

The user terminal 100 includes the above-mentioned control unit 110, communication unit 120, memory unit 130, and input-output unit 140.

In the user terminal 100, the control unit 110 reads a predetermined program to run an image acquisition module 150, an image receiving module 151, and a recognized object data acquisition module 152 in cooperation with the communication unit 120. Furthermore, in the user terminal 100, the control unit 110 reads a predetermined program to run an object storing module 161 and a boundary storing module 162 in cooperation with the memory unit 130. Still furthermore, in the user terminal 100, the control unit 110 reads a predetermined program to run an input receiving module 170 and a notification generating module 172 in cooperation with the input-output unit 140.

The camera 200 has the above-mentioned control unit 210, communication unit 220, and imaging unit 230.

In the camera 200, the control unit 210 reads a predetermined program to run to achieve an image acquisition request receiving module 240 and an image transmitting module 241 in cooperation with the communication unit 220. Furthermore, in the camera 200, the control unit 210 reads a predetermined program to run an imaging module 250 in cooperation with the imaging unit 230.

The object recognition server 10 includes a control unit 11 including a CPU, a RAM, and a ROM; and a communication unit 12 such as a device capable of communicating with other devices, for example, a Wireless Fidelity or Wi-Fi® enabled device complying with IEEE 802.11 in the same way as the user terminal 100.

The object recognition server 10 also includes a memory unit 13 that stores the object recognition database 101 to be described later, such as a hard disk, a semiconductor memory, a record medium, or a memory card to store data.

In the object recognition server 10, the control unit 11 reads a predetermined program to run an image data receiving module 20, a feature amount extraction module 21, and a recognized object data transmitting module 22 in cooperation with the communication unit 12. Furthermore, in the object recognition server 10, the control unit 11 reads a predetermined program to run a database storing module 30 and a recognized object data acquisition module 31 in cooperation with the memory unit 13.

### Object Recognition Process

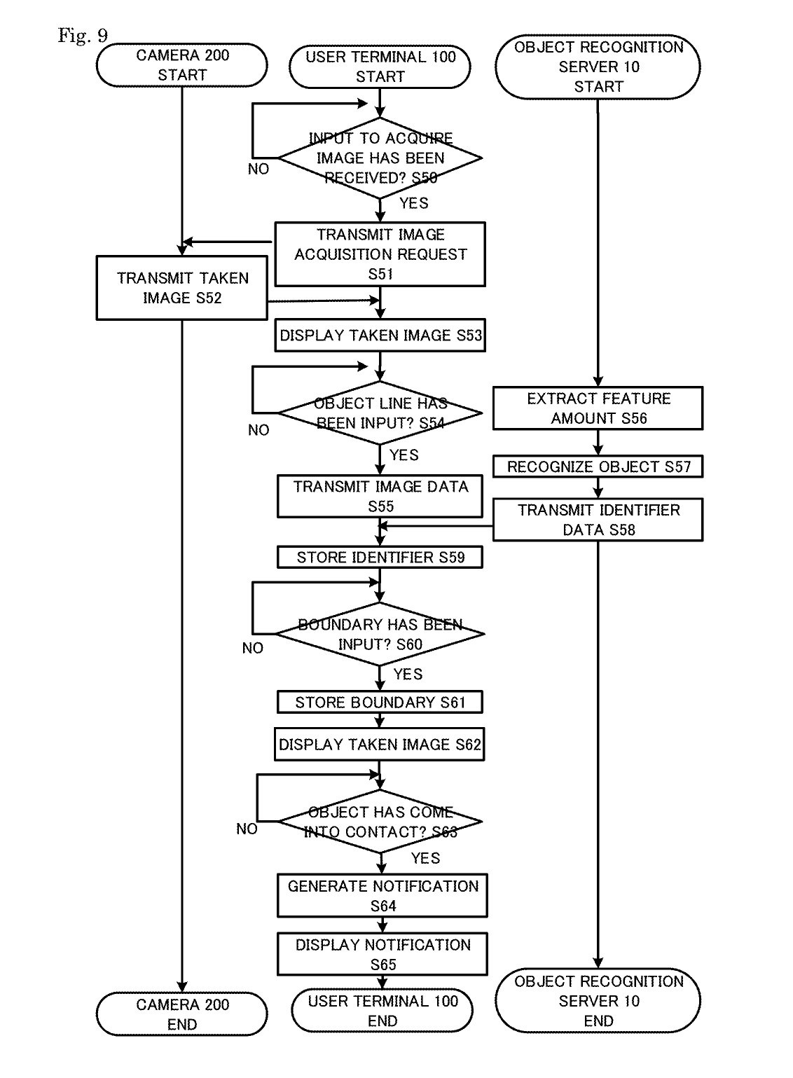

FIG. 9 shows a flow chart of the object recognition process performed by the object recognition server 10, the user terminal 100, and the camera 200 in the second embodiment. The tasks executed by the modules of the above-mentioned units will be described below with this process. The detailed explanation of the same process as that in the first embodiment is omitted.

First, the input receiving module 170 of the user terminal 100 judges whether or not the input receiving module 170 has received an input to acquire a moving or still image (step S50). The step S50 is processed in the same way as the above-mentioned step S20. In the step S50, if judging that the input receiving module 170 has not received an instruction to acquire an image (NO), the input receiving module 170 repeats the process until receiving the input.

On the other hand, if judging that the input receiving module 170 of the user terminal 100 has received an instruction to acquire an image (YES) in the step S50, the image acquisition module 150 of the user terminal 100 transmits an image acquisition request to the camera 200 (step S51). The step S51 is processed in the same way as the above-mentioned step S21.

The image acquisition request receiving module 240 of the camera 200 receives the image acquisition request transmitted from the user terminal 100. The imaging module 250 of the camera 200 images the imaging point contained in the image acquisition request. Then, the image transmitting module 241 of the camera 200 transmits the taken image to the user terminal 100 as image data (step S52). The step S52 is processed in the same way as the above-mentioned step S22.

The image data receiving module 151 of the user terminal 100 receives the image data transmitted from the camera 200. The input receiving module 170 of the user terminal 100 displays the image as shown in FIG. 11 based on the received image data (step S53). The step S53 is processed in the same way as the above-mentioned step S23.

The input receiving module 170 of the user terminal 100 judges whether or not an object line 103 specifying an object 102 to be recognized that is contained in the displaying image has been input (step S54). The step S54 is processed in the same way as the above-mentioned step S24.

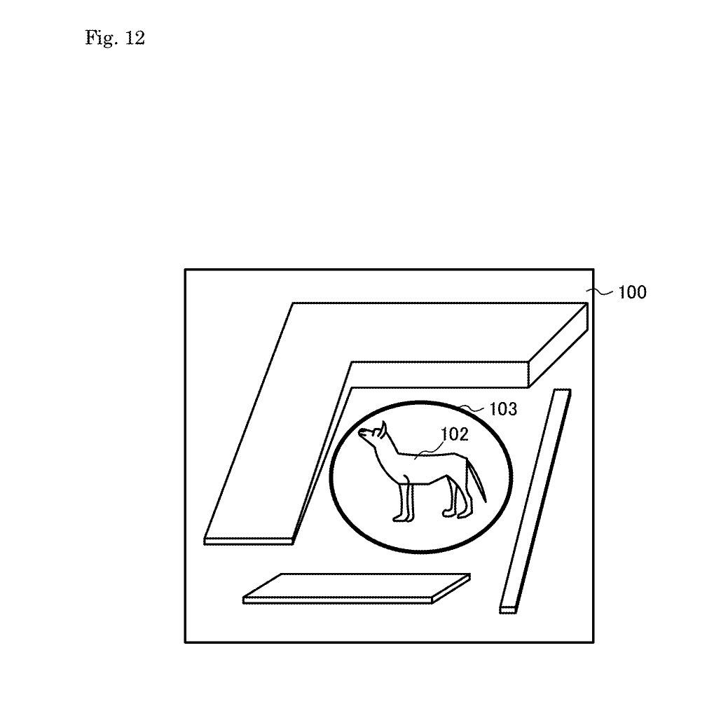

In the step S54, if judging that the input receiving module 170 of the user terminal 100 has not received an object line 103 (NO), the input receiving module 170 repeats the process until receiving an input of an object line 103. On the other hand, if judging that the input receiving module 170 of the user terminal 100 has received an object line 103 (YES) in the step S54 as shown in FIG. 12, the recognized object data acquisition module 152 of the user terminal 100 transmits image data on the area enclosed with this object line 103 (step S55).

The image data receiving module 20 of the object recognition server 10 receives the image data transmitted from the user terminal 100. The feature amount extraction module 21 of the object recognition server 10 extracts the feature amount of the object 102 contained in this received image data (step S56).

The recognized object data acquisition module 31 of the object recognition server 10 references the object recognition database 101 as shown in FIG. 13 based on the feature amount of the object 102 that is extracted in the step S56 and recognizes the object 102 in the area enclosed with the object line 103 (step S57).

### Object Recognition Database

FIG. 13 shows the object recognition database 101 that the database storing module 30 of the object recognition server 10 stores. The object recognition database 101 is the same as that in the first embodiment, and therefore the detailed explanation is omitted.

In the step S57, the recognized object data acquisition module 31 of the object recognition server 10 retrieves and acquires the identifier associated with this feature amount from the object recognition database 101 based on the feature amount of the object 102 extracted by the feature amount extraction module 21 of the object recognition server 10 to recognize the object 102.

The recognized object data transmitting module 22 of the object recognition server 10 transmits identifier data on the identifier acquired in the step S57 to the user terminal 100 (step S58).

The recognized object data acquisition module 152 of the user terminal 100 receives the identifier data transmitted from the object recognition server 10. The object storing module 161 of the user terminal 100 stores the acquired identifier as an object (step S59).

Then, the input receiving module 170 of the user terminal 100 judges whether or not a boundary 104 has been input in the displaying image (step S60). The step S60 is processed in the same way as the above-mentioned step S28. Therefore, the detailed explanation is omitted.

In the step S60, if judging that the input receiving module 170 of the user terminal 100 has not received a boundary 104 (NO), the input receiving module 170 repeats the process until receiving an input of a boundary 104. On the other hand, if judging that the input receiving module 170 has received a boundary 104 (YES) in the step S60 as shown in FIG. 14, the input receiving module 170 displays the received boundary 104 in the image, and then the boundary storing module 162 stores the location of the boundary 104 (step S61). The step S61 is processed in the same way as the above-mentioned step S29.

The image acquisition module 150 of the user terminal 100 acquires the image data taken with the camera 200 by performing the process steps same as the above-mentioned steps S21 to S23. The input receiving module 170 of the user terminal 100 displays the acquired image (step S62).

The input receiving module 170 of the user terminal 100 judges whether or not the object 102 contained in the acquired image data has come in contact with the boundary 104 received in the step S60 (step S63). In the step S63, if judging that the object 102 has not come in contact with the boundary 104 (NO), the input receiving module 170 repeat this step.

On the other hand, if the input receiving module 170 of the user terminal 100 judges that the object 102 has come in contact with the boundary 104 (YES) in the step S63 as shown in FIG. 15, the notification generating module 172 of the user terminal 100 generates the notification that the object 102 has come in contact with the boundary 104 (step S64).

The input receiving module 170 of the user terminal 100 displays the notification generated in the step S64 as a notification 105 as shown in FIG. 16 (step S65).

In the above-mentioned embodiment, the input receiving module 170 of the user terminal 100 receives an input of one object line 103 but may be a plurality of object lines 103. The input receiving module 170 receives an input of one boundary 104 but may be a plurality of boundaries 104. In this case, the notification may be generated if the object 102 has come in contact with any or all of the plurality of boundaries 104.

Moreover, the input receiving module 170 may receive an input of not only a consecutive lined boundary 104 but also a dashed lined boundary 104. In this case, the notification generating module 172 of the user terminal 100 may generate the notification if the object 102 has come in contact with the part where the boundary 104 exists, but may not if the object 102 has come in contact with the part where the boundary 104 does not exist.

### Change Process

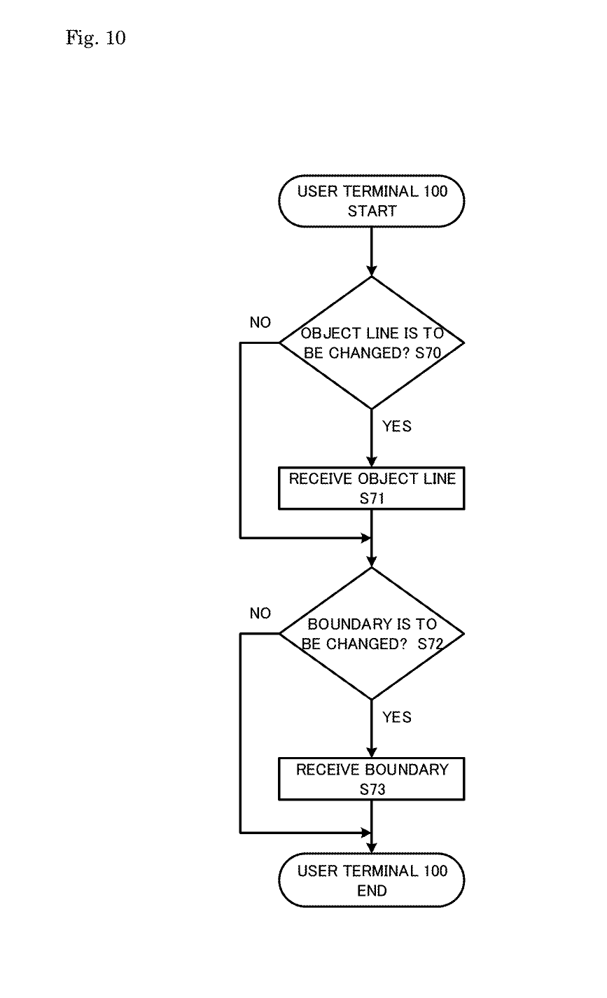

FIG. 10 shows a flow chart of the change process performed by the object recognition server 10. The tasks executed by the modules of the above-mentioned units are explained below together with this process. This process only has to be performed any time after the step S55 in the above-mentioned object recognition process.

First, the input receiving module 170 of the user terminal 100 judges whether or not the input receiving module 170 has received an input to change the object 102 (step S70). The step S70 is processed in the same way as the above-mentioned step S40. Therefore, the detailed explanation is omitted. If judging that the input receiving module 170 has not received an input to change the object 102 (NO) in the step 70, the input receiving module 170 judges whether or not the input receiving module 170 has received an input to change the boundary 104 to be described later (step S72).

If judging that the input receiving module 170 of the user terminal 100 has received an input to change the object 102 (YES) in the step 70, the input receiving module 170 displays the image based on the image data acquired from the camera 200 and receives an input of an object 102 again (step S71). In the step S71, the user terminal 100 and the object recognition server 10 perform the process of the above-mentioned steps S55 to S59. The object storing module 161 of the user terminal 100 deletes the information on the stored object 102. In the step S71, the object storing module 161 may not delete information but may add and store information on the newly received object 102.

In the step S72, the input receiving module 170 of the user terminal 100 judges whether or not the input receiving module 170 has received an input of a boundary change notice 107 as shown in FIG. 18. In the step S72, if judging that the input receiving module 170 has not received an input to change the boundary 104 (NO), the input receiving module 170 ends this process.

If judging that the input receiving module 170 of the user terminal 100 has received an input to change the boundary 104 (YES) in the step 72, the input receiving module 170 displays the image based on the image data acquired from the camera 200 and receives an input of a boundary 104 again (step S73). The step S73 is processed in the same way as the above-mentioned step S43.

If the object 102 is changed, the notification generating module 172 of the user terminal 100 generates the notification that this changed object 102 has come in contact with the boundary 104. If the boundary 104 is changed, the notification generating module 172 of the user terminal 100 generates the notification that the object 102 has come in contact with this changed boundary 104.

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

1 Object recognition system

10 Object recognition server

100 User terminal

200 Camera

What is claimed is:

1. A user terminal that notifies the movement of an object imaged with a camera to a user, comprising:
an object receiving unit that receives an object specified by on-screen guide from the user;
an object recognition unit that recognizes the image of the specified object, references an object recognition database, and extracts a feature amount to recognize the object;
a boundary receiving unit that receives a predetermined boundary input by on-screen guide from the user; and
a notification unit that provides a notification when the recognized object comes in contact with the boundary.

2. The user terminal according to claim 1, further comprising a boundary change unit that changes the received boundary, wherein the notification unit provides a notification when the recognized object comes in contact with the changed boundary.

3. The user terminal according to claim 1, wherein the boundary receiving unit receives a plurality of predetermined boundaries input, and the notification unit that provides a notification when the recognized object comes in contact with one or some of the received boundaries.

4. An object recognition server being communicatively connected with a user terminal that notifies the movement of an object imaged with a camera to a user, comprising:
an object recognition database that associates and stores the identifier of an object with the feature amount of the object;
an object information receiving unit that receives information on an object specified from the user terminal;
an object recognition unit that looks up the object recognition server, and extracts a feature amount, and acquires the identifier of the object, based on the received information, to recognize the object; and
an identifier transmitting unit that transmits the identifier of the recognized object to the user terminal.

5. A method for notification that notifies the movement of an object imaged with a camera to a user, comprising the steps of;
receiving an object specified by on-screen guide from the user;
recognizing the image of the specified object, referencing an object recognition database, and extracting a feature amount to recognize the object;
receiving a predetermined boundary input by on-screen guide from the user; and
providing a notification when the recognized object comes in contact with the boundary.
